(19) United States
(12) Patent Application Publication
(10) Pub. No.: US 2020/0285003 A1
(43) Pub. Date: Sep. 10, 2020

(54) PHOTOELECTRIC CONVERSION MODULE AND ACTIVE OPTICAL CABLE

(71) Applicant: Fujikura Ltd., Tokyo (JP)

(72) Inventors: Masato Takigahira, Sakura-shi (JP); Keisuke Yamazaki, Tokyo (JP)

(73) Assignee: Fujikura Ltd., Tokyo (JP)

(21) Appl. No.: 16/066,098

(22) PCT Filed: Jan. 13, 2017
(86) PCT No.: PCT/JP2017/001103

§ 371 Date: Jun. 26, 2018

(30) Foreign Application Priority Data
Jan. 14, 2016 (JP) 2016-004966

(51) Int. Cl. G02B 6/42

(52) U.S. Cl. CPC G02B 6/4212; G02B 6/4249; G02B 6/4214

(57) ABSTRACT

A photoelectric conversion module 1 includes a photoelectric conversion element 20 which has a light receiving/emitting unit 25 to receive or emit light; an optical fiber 30 which has one end portion fixed to the photoelectric conversion element 20; and a light transmitting resin 41 which fixes the one end portion of the optical fiber 30 and the photoelectric conversion element 20, reflects light by a predetermined region 42 of a surface thereof, and optically couples a core 31 of the optical fiber 30 and the light receiving/emitting unit 25. An outer circumferential surface of a clad 32 at the one end portion of the optical fiber 30 contacts an element surface 21 from which the light receiving/emitting unit 25 is exposed at a position not overlapping a center of the light receiving/emitting unit 25 in the photoelectric conversion element 20.

### TECHNICAL FIELD

The present invention relates to a photoelectric conversion module suitable for performing photoelectric conversion with high efficiency and an active optical cable.

### BACKGROUND ART

As a photoelectric conversion module, there is a photoelectric conversion module in which a photoelectric conversion element performing conversion of light energy and electric energy and an optical fiber are fixed to each other and light propagates between the photoelectric conversion element and the optical fiber. In the photoelectric conversion module, a signal is converted from an optical signal to an electric signal or a signal is converted from an electric signal to an optical signal. Examples of the photoelectric conversion module can include a photoelectric conversion module in which an optical fiber is fixed to a laser diode (LD) and light emitted from the laser diode is propagated through an optical fiber and a photoelectric conversion module in which an optical fiber is connected to a photodiode (PD) and light emitted from the optical fiber is received by the photodiode.

Such an optical module is described in the following Patent Literature 1. In the optical module described in the following Patent Literature 1, an optical fiber is disposed at a predetermined interval on an optical semiconductor element to be a photoelectric conversion element, a transparent resin is filled between the optical semiconductor element and the optical fiber, and the optical fiber is fixed to an optical semiconductor. The transparent resin is also filled between a light receiving/emitting unit of the optical semiconductor element and an end face of the optical fiber and has an inclined surface inclined with respect to each of a longitudinal direction of the optical fiber and a direction perpendicular to a light receiving/emitting surface. The transparent resin is an optical coupling unit that reflects light by the inclined surface and optically couples the light receiving/emitting unit of the optical semiconductor element and a core of the optical fiber. Therefore, light emitted from the light receiving/emitting unit of the optical semiconductor element is incident on the core of the optical fiber through the optical coupling unit and light emitted from the core of the optical fiber is incident on the light receiving/emitting unit of the optical semiconductor element through the optical coupling unit.

### [Patent Literature 1] WO 2011/083812 A

### SUMMARY OF INVENTION

In the optical module described in the above Patent Literature 1, the optical coupling unit is formed of the resin, so that highly efficient optical transmission can be performed at a low cost. However, a photoelectric conversion module in which a loss of light is further reduced is required.

Accordingly, it is an object of the present invention to provide a photoelectric conversion module in which a loss of light is reduced and an active optical cable.

A photoelectric conversion module according to the present invention includes a photoelectric conversion element which has a light receiving/emitting unit to receive or emit light; an optical fiber which has one end portion fixed to the photoelectric conversion element; and a light transmitting resin which fixes the one end portion of the optical fiber and the photoelectric conversion element, reflects light by a predetermined region of a surface thereof, and optically couples a core of the optical fiber and the light receiving/emitting unit. An outer circumferential surface of a clad at the one end portion of the optical fiber contacts an element surface from which the light receiving/emitting unit is exposed at a position not overlapping a center of the light receiving/emitting unit in the photoelectric conversion element.

According to the photoelectric conversion module, because the outer circumferential surface of the clad at one end portion of the optical fiber fixed to the photoelectric conversion element contacts the element surface, a length of an optical path between the core of the optical fiber and the light receiving/emitting unit can be shortened in the light transmitting resin, as compared with the case where the optical fiber and the photoelectric conversion element are separated from each other as in the above Patent Literature 1. In the case where the photoelectric conversion element is a light emitting element, because light emitted from the light emitting element spreads, spreading of light is suppressed by shortening an optical path length to the optical fiber and an amount of light coupled to the core of the optical fiber can be increased. Also, because the light emitted from the optical fiber spreads, in the case where the photoelectric conversion element is a light receiving element, spreading of light is suppressed by shortening an optical path length to the light receiving element and an amount of light coupled to the light receiving element can be increased. In addition, the optical fiber is disposed at the position not overlapping the center of the light receiving/emitting unit. Preferably, the center of the light receiving/emitting unit is generally a position where the light intensity is highest and the center and the core of the optical fiber are optically coupled. Therefore, the optical fiber is disposed at the position not overlapping the center of the light receiving/emitting unit, so that it is possible to suppress loss of a part of the light with the highest intensity due to reflection or refraction in a side surface of the clad of the optical fiber or a side surface of the core. In this way, a coupling loss of light in the core of the optical fiber and the light receiving/emitting unit of the photoelectric conversion element can be suppressed. Therefore, according to the photoelectric conversion module according to the present invention, a loss of light can be reduced.

As described above, because the outer circumferential surface of the clad at one end portion of the optical fiber fixed to the photoelectric conversion element contacts the element surface, the end portion of the optical fiber hardly moves and moving of the end portion of the optical fiber in a direction perpendicular to the element surface in particular is suppressed, as compared with the case where the optical fiber and the photoelectric conversion element are separated from each other as in the photoelectric conversion module described in the above Patent Literature 1. The movement of the end portion of the optical fiber may tend to lead to an increase in the coupling loss of the light in the core of the optical fiber and the light receiving/emitting unit of the photoelectric conversion element. In addition, because the viscosity of the light transmitting resin tends to decrease under a high temperature environment, the coupling loss of the light due to the movement of the end portion of the optical fiber is more likely to increase. However, in the photoelectric conversion module according to the present invention, because the end portion of the optical fiber hardly moves as described above, optical coupling between the light receiving/emitting surface and the core of the optical fiber is stabilized and an increase in the coupling loss of the light in the core and the light receiving/emitting unit can be suppressed.

In addition, as described above, because the outer circumferential surface of the clad at one end portion of the optical fiber fixed to the photoelectric conversion element contacts the element surface, the photoelectric conversion module can realize height reduction, as compared with the case where the optical fiber and the photoelectric conversion element are separated from each other as in the photoelectric conversion module described in the above Patent Literature 1.

Preferably, a distance between an end face of the optical fiber and a center position of the light receiving/emitting unit in a longitudinal direction of the optical fiber is equal to a distance from the element surface to a center of the core.

By disposing the optical fiber in the photoelectric conversion element in such a manner, an optical path length of the light propagating through the light transmitting resin can be shortened and the coupling loss of the light in the core of the optical fiber and the light receiving/emitting unit of the photoelectric conversion element can be further reduced.

Preferably, the predetermined region of the surface of the light transmitting resin reflecting the light is inclined at 40 degrees to 50 degrees with respect to a direction perpendicular to the light receiving/emitting unit.

It has been found that, when the light is reflected at an angle within the above range and the core and a light receiving/emitting surface are optically coupled, the coupling loss of the light in the core of the optical fiber and the light receiving/emitting unit of the photoelectric conversion element can be sufficiently reduced, as compared with the case where the light is reflected at an angle outside the above range and the core and the light receiving/emitting unit are optically coupled. In addition, it has been found that, when the light is reflected at an angle within the above range, an increase in the coupling loss of the light in the core and the light receiving/emitting unit can be suppressed even if a position of a tip of the optical fiber deviates in the longitudinal direction. Therefore, the loss of the light can be further reduced by adopting the above configuration.

Preferably, the photoelectric conversion module further includes a substrate to which the photoelectric conversion element is fixed and a fixing resin which fixes the optical fiber to the substrate and the light transmitting resin is softer than the fixing resin.

According to this configuration, the optical fiber is firmly fixed to the substrate rather than the photoelectric conversion element. As a result, a movement of the optical fiber with respect to the substrate is strongly regulated and a movement of the optical fiber with respect to the photoelectric conversion element fixed to the substrate is also regulated. Therefore, a state in which the loss of the light is reduced can be maintained. Even if the fixing resin deforms due to some reason and the end portion of the optical fiber moves due to the deformation, the light transmitting resin softer than the fixing resin absorbs the movement, so that it is possible to suppress damage to the optical fiber or damage to the photoelectric conversion element.

Preferably, a plurality of the light receiving/emitting units, a plurality of the optical fibers, and a plurality of the light transmitting resins are provided, the plurality of optical fibers is gathered by a coating resin and is led out from the coating resin by a predetermined length so that the clad is exposed at the one end portion, each of the light transmitting resins individually fixes the one end portion of each of the optical fibers to the photoelectric conversion element, reflects light by the predetermined region of the surface thereof, and optically couples the core of each of the optical fibers and each of the light receiving/emitting units individually, and the outer circumferential surface of the clad at the one end portion of each of the optical fibers contacts the element surface at a position not overlapping the center of the light receiving/emitting unit.

In the photoelectric conversion module, the multicore optical fiber in which the plurality of optical fibers is gathered as described above is used. Even when the multicore optical fiber is used, as described above, each optical fiber contacts the element surface at the position not overlapping the center of the light receiving/emitting unit and each light transmitting resin optically connects the core of each optical fiber and the light receiving/emitting surface individually. Therefore, in the photoelectric conversion module, the loss of the light can be reduced while the multicore optical fiber is used. According to the photoelectric conversion module, because the movement of the end portion of the optical fiber is suppressed, an increase in the coupling loss of the light in the core and the light receiving/emitting unit can be suppressed and height reduction can be realized. As a form in which a plurality of light receiving/emitting units is provided, a form in which a plurality of photoelectric conversion elements is provided and a form in which the photoelectric conversion element has a plurality of light receiving/emitting units can be exemplified.

As described above, when the plurality of light receiving/emitting units, the plurality of optical fibers, and the plurality of light transmitting resins are provided, the photoelectric conversion module preferably further includes a substrate to which the photoelectric conversion element is fixed and a fixing resin which fixes each of the optical fibers to the substrate and the light transmitting resin is preferably softer than the fixing resin.

According to this configuration, each optical fiber is firmly fixed to the substrate rather than the photoelectric conversion element. As a result, a movement of the optical fiber with respect to the substrate is strongly regulated and a movement of the optical fiber with respect to the photoelectric conversion element fixed to the substrate is also regulated. Therefore, a state in which the loss of the light is reduced can be maintained. Even if the fixing resin deforms due to some reason and the end portion of the optical fiber moves due to the deformation, the light transmitting resin softer than the fixing resin absorbs the movement, so that it is possible to suppress damage to the optical fiber or damage to the photoelectric conversion element.

An active optical cable according to the present invention includes a light emitting element which has a light emitting unit to emit light; a light receiving element which has a light receiving unit to receive the light; an optical fiber which has one end portion fixed to the light emitting element and the other end portion fixed to the light receiving element; a first light transmitting resin which fixes the one end portion of the optical fiber and the light emitting element, reflects light by a predetermined region of a surface thereof, and optically couples a core of the optical fiber and the light emitting unit; and a second light transmitting resin which fixes the other end portion of the optical fiber and the light receiving element, reflects light by a predetermined region of a surface thereof, and optically couples the core of the optical fiber and the light receiving unit. An outer circumferential surface of a clad at the one end portion of the optical fiber contacts a light emitting element surface from which the light emitting unit is exposed at a position not overlapping a center of the light emitting unit in the light emitting element and an outer circumferential surface of the clad at the other end portion of the optical fiber contacts a light receiving element surface from which the light receiving unit is exposed at a position not overlapping a center of the light receiving unit in the light receiving element.

The active optical cable includes the photoelectric conversion module having the light emitting element, the optical fiber, and the first light transmitting resin and the photoelectric conversion module having the light receiving element, the optical fiber, and the second light transmitting resin. That is, the active optical cable includes a set of photoelectric conversion modules for transmitting and receiving light. In the active optical cable, because the loss of the light can be reduced in each photoelectric conversion module, efficient optical communication can be performed. In addition, in the active optical cable, the movement of the end portion of the optical fiber is suppressed in each photoelectric conversion module and an increase in the coupling loss of the light in the core and the light receiving/emitting unit can be suppressed, so that stable optical communication can be performed. In addition, in the active optical cable, because each photoelectric conversion module can realize the height reduction, miniaturization can be realized.

As described above, according to the present invention, a photoelectric conversion module in which a loss of light is reduced and an active optical cable are provided.

### BRIEF DESCRIPTION OF DRAWINGS

FIG. 1 is a plan view showing a photoelectric conversion module according to a first embodiment of the present invention.

FIG. 2 is a cross-sectional view of the photoelectric conversion module of FIG. 1.

FIG. 3 is an enlarged view of an end portion of an optical fiber and a photoelectric conversion element in FIG. 2.

FIG. 4 is a diagram showing a relation of a ratio of an outer diameter D₁ of a clad of the optical fiber to a distance D₂ between an end face of the optical fiber along a longitudinal direction of the optical fiber and a center position of a light receiving/emitting unit and an increase amount of a coupling loss of light occurring between the optical fiber and the light receiving/emitting unit.

FIG. 5 is a plan view showing an active optical cable according to the first embodiment of the present invention.

FIG. 6 is a plan view showing a photoelectric conversion module according to a second embodiment of the present invention.

FIG. 7 is a plan view showing an active optical cable according to the second embodiment of the present invention.

### DESCRIPTION OF EMBODIMENTS

Hereinafter, preferred embodiments of a photoelectric conversion module and an active optical cable according to the present invention will be described in detail with reference to the drawings.

### First Embodiment

### <Photoelectric Conversion Module>

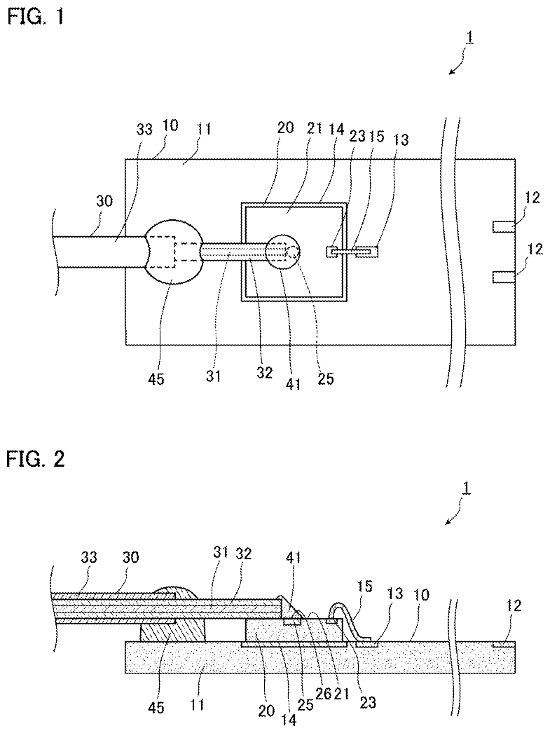

First, a photoelectric conversion module according to this embodiment will be described. FIG. 1 is a plan view showing a photoelectric conversion module according to a first embodiment of the present invention and FIG. 2 is a cross-sectional view of the photoelectric conversion module of FIG. 1.

As shown in FIGS. 1 and 2, a photoelectric conversion module 1 according to this embodiment includes a substrate 10, a photoelectric conversion element 20, an optical fiber 30, a light transmitting resin 41, and a fixing resin 45 as a main configuration.

In this embodiment, the substrate 10 is a printed wiring board and includes a substrate body 11 and terminals 12 and lands 13 and 14 formed on the substrate body 11. The substrate body 11 is a plate-like member made of an insulator such as glass epoxy or ceramic. In addition, each of the terminals 12 and the lands 13 and 14 is made of a conductor such as copper plating, the land 13 is a land to be connected to a signal terminal of the photoelectric conversion element 20, the land 14 is a land to be connected to a ground terminal of the photoelectric conversion element 20, and the terminals 12 are terminals to be connected to external devices. One terminal 12 and the land 13, and the other terminal 12 and the land 14 are electrically connected to each other via wiring lines not shown in the drawings or other electronic components.

The photoelectric conversion element 20 is fixed to the substrate 10. The photoelectric conversion element 20 is an element in which a light receiving/emitting unit 25 made of InGaP (indium gallium phosphide) or the like is provided on a base made of GaAs (gallium arsenide) or the like and may be called an optical semiconductor element. The photoelectric conversion element 20 is a light receiving element for performing conversion from an optical signal to an electric signal or a light emitting element for performing conversion from an electric signal to an optical signal. Since the photoelectric conversion element 20 performs light reception or light emission as described above, a light receiving/emitting surface 26 of the light receiving/emitting unit 25 is exposed from an element surface 21 to be a predetermined surface of the photoelectric conversion element 20. The light receiving/emitting unit 25 performs light reception or light emission.

As an example of the case where the photoelectric conversion element 20 is a light receiving element, a photodiode or the like can be exemplified. In this case, the light receiving/emitting unit 25 is a light receiving unit, the element surface 21 is a light receiving element surface, and the light receiving unit is exposed from the light receiving element surface. In addition, as an example of the case where the photoelectric conversion element 20 is a light emitting element, a laser diode or the like can be exemplified. In this case, the light receiving/emitting unit 25 is a light emitting unit, the element surface 21 is a light emitting element surface, and the light emitting unit is exposed from the light emitting element surface.

In this embodiment, the photoelectric conversion element 20 has one light receiving/emitting unit 25. In the photoelectric conversion element 20, a signal terminal is formed on the element surface 21 and a ground terminal not shown in the drawings is formed on the side opposite to the element surface 21. The terminal 23 and the land 13 of the substrate 10 are electrically connected via a wiring line 15 and the ground terminal not shown in the drawings and the land 14 of the substrate are electrically connected. The wiring line 15 is a conductive wiring line and is made of a metal such as gold, aluminum, and copper, for example. Although different from this embodiment, the ground terminal may be formed on the element surface 21. In this case, a land electrically connected to the ground terminal is provided separately from the land 13 and the ground terminal and the land are electrically connected by a wiring line or the like.

In addition, the optical fiber 30 is fixed to the element surface 21 of the photoelectric conversion element 20. The optical fiber 30 has a core 31, a clad 32 surrounding an outer circumferential surface of the core 31, and a protective layer 33 covering an outer circumferential surface of the clad 32. A refractive index of the core 31 is higher than a refractive index of the clad 32. Examples of the optical fiber can include a quartz optical fiber in which the core 31 and the clad 32 are formed of quartz, a plastic optical fiber in which the core 31 and the clad 32 are made of plastic, a polymer clad coated optical fiber in which the core is formed of quartz and the clad is formed of plastic, and the like. The protective layer 33 is formed of a photocurable resin or the like, for example.

The optical fiber 30 is, for example, a multimode fiber that propagates light of a plurality of modes. Although an outer diameter of the clad 32 is not particularly limited, the outer diameter is, for example, 125 μm and a diameter of the core 31 is, for example, 50 μm in the case of the multimode fiber. The optical fiber 30 may be a single mode fiber that propagates only light of a basic mode. In this case, the diameter of the core 31 is, for example, 10 μm.

The optical fiber 30 is led out by a predetermined length so that the clad 32 is exposed from the protective layer 33 at one end portion of the side fixed to the photoelectric conversion element 20. In this embodiment, an end face of the optical fiber 30 is perpendicular to a longitudinal direction. As shown in FIG. 2, if this length is set to a lead-out length L, the lead-out length L is preferably 10 μm to 15 mm, more preferably, 1.5 mm to 2.5 mm. One end portion of the optical fiber 30 from which the clad 32 has been led out is disposed on the photoelectric conversion element 20 so that an outer circumferential surface of the clad 32 contacts the element surface 21 of the photoelectric conversion element 20. The optical fiber 30 is disposed so that a center axis of the core 31 of the optical fiber 30 passes through a center of the light receiving/emitting unit 25 and at least a center of the light receiving/emitting surface 26 is exposed, when the element surface 21 is viewed in planar view. That is, one end portion of the optical fiber 30 is disposed on the photoelectric conversion element 20 to contact the element surface 21 at a position not overlapping the center of the light receiving/emitting unit 25. As shown in FIG. 2, one end portion of the optical fiber 30 is more preferably disposed on the photoelectric conversion element 20 to contact the element surface 21 at a position not overlapping the entire light receiving/emitting unit 25.

In a state in which one end portion of the optical fiber 30 is disposed on the photoelectric conversion element 20, in this embodiment, the protective layer 33 of the optical fiber 30 and a part of the clad 32 exposed from the protective layer 33 are fixed to the substrate 10 by the fixing resin 45. The fixing resin 45 is a hard resin and is, for example, a photocurable resin such as an acrylic resin, an epoxy resin, a silicon resin, or a resin obtained by mixing or synthesizing these resins. By the fixing resin 45, a movement of the position of the optical fiber 30 is suppressed.

In addition, one end portion of the optical fiber 30 disposed on the photoelectric conversion element 20 is fixed to the photoelectric conversion element 20 by the light transmitting resin 41. The light transmitting resin is made of a resin that transmits light propagating through the optical fiber 30. Examples of the resin can include a photocurable resin such as an acrylic resin, an epoxy resin, a silicon resin, or a resin obtained by mixing or synthesizing these resins.

The light transmitting resin 41 is preferably softer than the fixing resin 45. If the light transmitting resin 41 is harder than the fixing resin 45, in the case where a vibration or the like is applied to the photoelectric conversion module 1 and the fixing resin is deformed, a stress may be applied to the optical fiber 30 to damage the led-out optical fiber 30 or the end portion of the optical fiber 30 may move and the stress due to the movement of the end portion may be applied to the photoelectric conversion element 20 to damage the photoelectric conversion element 20. However, if the light transmitting resin 41 is softer than the fixing resin 45 as described above, in the case where the fixing resin 45 is deformed, the end portion of the optical fiber 30 can move due to the deformation and the stress for the optical fiber 30 can be alleviated by the movement or the light transmitting resin 41 can absorb the movement of the end portion of the optical fiber 30, thereby suppressing the damage on the photoelectric conversion element 20.

Next, a position relation of the optical fiber 30 and the light receiving/emitting unit 25, a shape of the light transmitting resin 41, and the like will be described in detail.

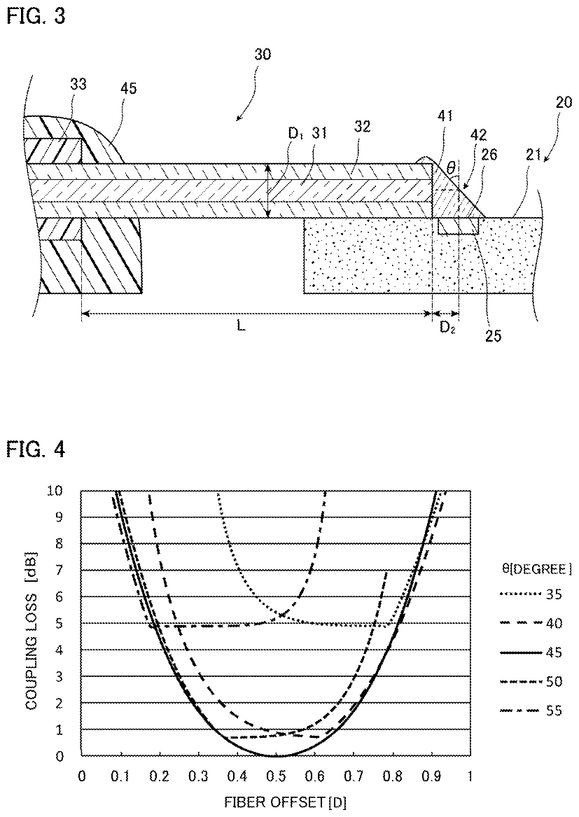

FIG. 3 is an enlarged view of the end portion of the optical fiber 30 and the photoelectric conversion element 20 shown in FIG. 2. As shown in FIG. 3 in which an optical axis is shown by a broken line, light propagating between the optical fiber 30 and the light receiving/emitting unit 25 is reflected by a predetermined region 42 of a surface of the light transmitting resin 41 and propagates. The predetermined region 42 of the surface of the light transmitting resin 41 faces the core 31 at a predetermined inclination angle on the end face of the optical fiber 30 and faces the light receiving/emitting unit 25 at a predetermined inclination angle, to reflect the light as described above. Therefore, the predetermined region 42 of the surface of the light transmitting resin 41 can be understood as a reflection unit.

If the outer diameter of the clad of the optical fiber 30 is set to D₁, the outer circumferential surface of the clad 32 contacts the element surface 21 as described above, so that a distance from the element surface 21 to the center of the core 31 of the optical fiber 30 is D₁/2. In addition, a distance between the end face of the optical fiber 30 along the longitudinal direction of the optical fiber 30 and the center position of the light receiving/emitting unit 25 is set to D₂. In this case, in this embodiment, the distance D₁/2 and the distance D₂ are equal to each other. As such, because the distance D₁/2 and the distance D₂ are equal to each other, an optical path length of the light that is reflected by the predetermined region 42 of the surface of the light transmitting resin 41 and propagates between the optical fiber 30 and the light receiving/emitting unit 25 can be minimized.

FIG. 4 is a diagram showing a relation between a ratio of the outer diameter D₁ to the distance D₂ and an increase amount of a coupling loss of light occurring between the optical fiber 30 and the light receiving/emitting unit 25. Here, an angle of the predetermined region 42 reflecting light with respect to a direction perpendicular to the light receiving/emitting surface 26 of the light receiving/emitting unit 25 is set to θ. In FIG. 4, the above relation is shown every angle θ.

As shown in FIG. 4, the coupling loss of the light is smallest when the angle θ is 45 degrees and D₁/D₂ is 0.5. If D₁/D₂ is 0.5, it means that the distance D₂ in the longitudinal direction of the optical fiber 30 between the end face of the optical fiber 30 and the center position of the light receiving/emitting unit 25 is equal to the distance D₁/2 from the element surface 21 to the center of the core 31 of the optical fiber 30. In the case where the angle θ is 45 degrees, if the position of the end face of the optical fiber 30 deviates along the longitudinal direction of the optical fiber 30 and D₁/D₂ deviates from 0.5, the coupling loss of the light increases. However, even in the case where D₁/D₂ deviates from 0.5 by about 0.1 when the angle θ is 45 degrees, an increase amount of the coupling loss of the light is sufficiently small as less than 1 dB. If D₁/D₂ deviates by about 0.1, it means that a deviation of about 20 μm occurs when the outer diameter of the clad is 125 μm as described above.

In addition, when θ is 40 degrees and D₁/D₂ is about 0.6, the coupling loss of the light is smallest and a difference with the coupling loss of the light when the angle θ is 45 degrees and D₁/D₂ is 0.5 is approximately 0.7 dB. However, even if D₁/D₂ is 0.5, the coupling loss of the light does not change much as compared with the case when D₁/D₂ is 0.6. In addition, even when D₁/D₂ deviates from 0.5 by about 0.1, an increase amount of the coupling loss of the light is less than 1 dB and the coupling loss of the light is sufficiently suppressed. In addition, when 0 is 50 degrees and D₁/D₂ is about 0.35, the coupling loss of the light is smallest and a difference with the coupling loss of the light in a case where the angle θ is 45 degrees and D₁/D₂ is 0.5 is approximately 0.7 dB. However, even when D₁/D₂ is 0.5, the coupling loss of the light does not change much as compared with the case where D₁/D₂ is 0.35. In addition, even when D₁/D₂ deviates from 0.5 by about 0.1, an increase amount of the coupling loss of the light is less than 1 dB and the coupling loss of the light is sufficiently suppressed. That is, in the case where θ is 40 to 50, when D₁/D₂ deviates from 0.5 by about 0.1, that is, when D₁/D₂ is about 0.4 to 0.6, the coupling loss of the light can be sufficiently suppressed. On the other hand, as apparent from FIG. 4, when θ is 35 degrees or 55 degrees, the coupling loss of the light increases by about 5 dB as compared with the coupling loss of the light when the angle θ is 45 degrees and D₁/D₂ is 0.5.

As an example of forming the light transmitting resin 41, in a state in which the clad 32 is disposed on the element surface 21 of the photoelectric conversion element 20, a resin becoming the light transmitting resin 41 is dropped into the end portion of the optical fiber 30 and is cured. At this time, an amount, a viscosity, and the like of the resin to be dropped are controlled, so that it is possible to form the light transmitting resin 41 in which θ has been controlled.

Next, an operation of the photoelectric conversion module 1 will be described.

In the case where the photoelectric conversion element 20 of the photoelectric conversion module 1 is a light emitting element, an electric signal is input to the terminal 23 of the photoelectric conversion element 20 on the basis of an electric signal input to the terminal 12 of the photoelectric conversion module 1 and light is emitted from the light receiving/emitting unit 25. The light emitted from the light receiving/emitting unit 25 is reflected by the predetermined region 42 of the surface of the light transmitting resin 41, is incident on the core 31 of the optical fiber 30 from the end face, and propagates through the core 31 from one end portion to the other end portion.

On the other hand, in the case where the photoelectric conversion element 20 of the photoelectric conversion module 1 is a light receiving element, when light is emitted from the end face of the core 31 at one end portion of the optical fiber 30, the emitted light is received by the predetermined region 42 of the surface of the light transmitting resin 41 and is received by the light receiving/emitting unit 25. If the light is received by the light receiving/emitting unit 25, an electric signal is output from the terminal 23 of the photoelectric conversion element 20 and an electric signal based on the electric signal is output from the terminal 12 of the photoelectric conversion module 1.

As described above, in the photoelectric conversion module 1 according to this embodiment, the outer circumferential surface of the clad 32 at one end portion of the optical fiber 30 contacts the element surface 21 of the photoelectric conversion element 20 from which the light receiving/emitting unit 25 is exposed. Therefore, as compared with the case where the optical fiber 30 and the photoelectric conversion element 20 are separated from each other, the length of the optical path between the core 31 of the optical fiber 30 and the light receiving/emitting unit 25 in the light transmitting resin 41 can be shortened. In addition, because the optical fiber 30 is disposed at a position not overlapping the center of the light receiving/emitting unit 25, a part of the light entering and leaving the center of the light receiving/emitting unit 25 can be suppressed from being lost due to reflection or refraction in a side surface of the clad 32 or a side surface of the core 31. The light entering and leaving the center of the light receiving/emitting unit 25 is generally light with the highest intensity. Therefore, because the coupling loss of the light in the core 31 of the optical fiber 30 and the light receiving/emitting unit 25 of the photoelectric conversion element 20 can be suppressed, according to the photoelectric conversion module 1 according to this embodiment, a loss of the light can be reduced.

In addition, because the outer circumferential surface of the clad 32 at one end portion of the optical fiber 30 contacts the element surface 21, as compared with the case where the optical fiber 30 and the photoelectric conversion element 20 are separated from each other, the end portion of the optical fiber 30 hardly moves and moving of the end portion of the optical fiber 30 in a direction perpendicular to the element surface 21 in particular is suppressed. The movement of the end portion of the optical fiber 30 tends to lead to an increase in the coupling loss of the light in the core 31 and the light receiving/emitting unit 25. If the optical fiber 30 moves in the direction perpendicular to the element surface 21 in particular, the coupling loss of the light may further increase. In addition, because the viscosity of the light transmitting resin tends to decrease under a high temperature environment, the coupling loss of the light due to the movement of the end portion of the optical fiber is more likely to increase. However, in the photoelectric conversion module 1 according to this embodiment, because the end portion of the optical fiber 30 hardly moves as described above, optical coupling between the light receiving/emitting surface 26 and the core 31 of the optical fiber 30 is stabilized and an increase in the coupling loss of the light can be suppressed.

In addition, because the outer circumferential surface of the clad 32 at one end portion of the optical fiber 30 contacts the element surface 21 of the photoelectric conversion element 20, the photoelectric conversion module 1 can realize height reduction as compared with the case where the optical fiber 30 and the photoelectric conversion element 20 are separated from each other.

### <Active Optical Cable>

Next, an active optical cable according to this embodiment will be described.

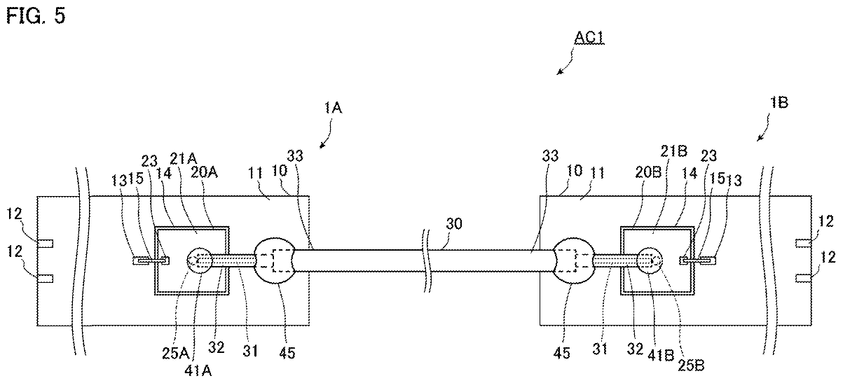

FIG. 5 is a plan view showing the active optical cable according to this embodiment. As shown in FIG. 5, an active optical cable AC1 according to this embodiment includes a photoelectric conversion module 1A and a photoelectric conversion module 1B. The photoelectric conversion module 1A and the photoelectric conversion module 1B use a common optical fiber 30.

The photoelectric conversion module 1A is a module in which the photoelectric conversion element 20 of the photoelectric conversion module 1 is replaced by a light emitting element 20A. That is, the photoelectric conversion module 1A is a light emitting module.

The light emitting element 20A has a light emitting unit 25A corresponding to the light receiving/emitting unit of the photoelectric conversion element 20 of the photoelectric conversion module 1 and the element surface 21 of the photoelectric conversion module 1 corresponds to a light emitting element surface 21A of the light emitting element 20A. One end portion of the optical fiber 30 is fixed to the light emitting element 20A. Specifically, one end portion of the optical fiber 30 is led out in the same manner as one end portion of the optical fiber 30 of the photoelectric conversion module 1. In addition, one end portion of the optical fiber 30 that has been led out is disposed to contact the light emitting element surface 21A at a position where the outer circumferential surface of the clad 32 does not overlap the center of the light emitting unit 25A of the light emitting element 20A. One end portion of the optical fiber 30 disposed in this manner is fixed by a first light transmitting resin 41A having the same configuration as the configuration of the light transmitting resin 41 of the photoelectric conversion module 1 in the same manner as the case where one end portion of the optical fiber 30 of the photoelectric conversion module 1 is fixed to the photoelectric conversion element 20 by the light transmitting resin 41. One end portion of the optical fiber 30 is more preferably disposed to contact the light emitting element surface 21A at a position not overlapping the entire light emitting unit 25A of the light emitting element 20A.

In addition, the photoelectric conversion module 1B is a module in which the photoelectric conversion element 20 of the photoelectric conversion module 1 is replaced by a light receiving element 20B. That is, the photoelectric conversion module 1B is a light receiving module.

The light receiving element 20B has a light receiving unit 25B corresponding to the light receiving/emitting unit 25 of the photoelectric conversion element 20 of the photoelectric conversion module 1 and the element surface 21 of the photoelectric conversion module 1 corresponds to a light receiving element surface 21B of the light receiving element 20B. The other end portion of the optical fiber 30 is fixed to the light receiving element 20B. Specifically, the other end portion of the optical fiber 30 is led out in the same manner as one end portion of the optical fiber 30 of the photoelectric conversion module 1. In addition, the other end portion of the optical fiber 30 that has been led out is disposed to contact the light receiving element surface 21B at a position where the outer circumferential surface of the clad 32 does not overlap a center of the light receiving unit 25B of the light receiving element 20B. The other end portion of the optical fiber 30 disposed in this manner is fixed by a second light transmitting resin 41B having the same configuration as the configuration of the light transmitting resin 41 of the photoelectric conversion module 1 in the same manner as the case where one end portion of the optical fiber 30 of the photoelectric conversion module 1 is fixed to the photoelectric conversion element 20 by the light transmitting resin 41. The other end portion of the optical fiber 30 is more preferably disposed to contact the light receiving element surface 21B at a position not overlapping the entire light receiving unit 25B of the light receiving element 20B.

In the active optical cable AC1 having the above configuration, an electric signal is input to the terminal 23 of the light emitting element 20A on the basis of an electric signal input to the terminal 12 of the photoelectric conversion module 1A and light is emitted from the light emitting unit 25A. The light emitted from the light emitting unit 25A is reflected by a predetermined region of a surface of the first light transmitting resin 41A and is incident on the core 31 of the optical fiber 30. The light then propagates through the core 31 from one end portion of the optical fiber 30 to the other end portion. The light emitted from the core 31 at the other end portion is reflected by a predetermined region of a surface of the second light transmitting resin 41B and is received by the light receiving unit 25B. When the light is received by the light receiving unit 25B, an electric signal is output from the terminal of the light receiving element 20B and an electric signal based on the electric signal is output from the terminal 12 of the photoelectric conversion module 1B.

As described above, in the active optical cable AC1, the loss of the light can be reduced in each of the photoelectric conversion modules 1A and 1B in the same manner as the photoelectric conversion module 1. Therefore, efficient optical communication can be performed. In addition, in the active optical cable AC1, the movement of the end portion of the optical fiber 30 in each of the photoelectric conversion modules 1A and 1B is suppressed in the same manner as the photoelectric conversion module 1 and an increase in the coupling loss of the light in the core 31 of the optical fiber 30 and the light receiving/emitting unit 25 of the photoelectric conversion element 20 can be suppressed. Therefore, stable optical communication can be performed. In addition, in the active optical cable AC1, because each of the photoelectric conversion modules 1A and 1B can realize height reduction in the same manner as the photoelectric conversion module 1, miniaturization can be realized.

### Second Embodiment

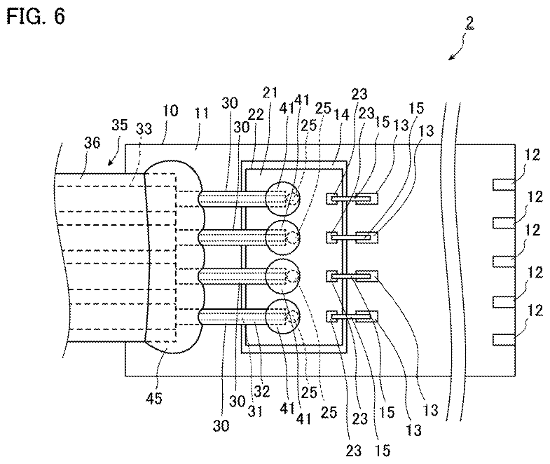

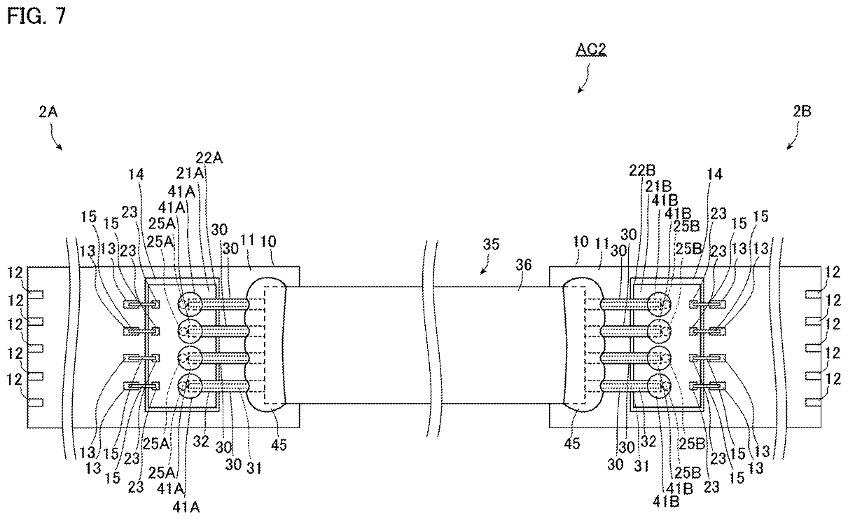

Next, a second embodiment of the present invention will be described in detail with reference to FIGS. 6 and 7. Components equal to or equivalent to those in the first embodiment are denoted by the same reference numerals and redundant explanation is omitted, unless particularly described.

### <Photoelectric Conversion Module>

FIG. 6 is a plan view showing a photoelectric conversion module according to the second embodiment of the present invention.

A photoelectric conversion module 2 according to this embodiment is different from a photoelectric conversion module 1 according to the first embodiment in that a photoelectric conversion element 22 is used instead of a photoelectric conversion element 20 according to the first embodiment and a multicore optical fiber 35 is used instead of an optical fiber 30 according to the first embodiment.

The photoelectric conversion element 22 is different from the photoelectric conversion element 20 according to the first embodiment in that the photoelectric conversion element 22 includes a plurality of light receiving/emitting units 25 equal to a light receiving/emitting unit 25 according to the first embodiment and includes the number of terminals 23 based on the number of light receiving/emitting units 25. Each of the terminals 23 is electrically connected to each of the lands 13 by a wiring line 15, the number of lands being provided according to the number of terminals 23 provided in the substrate 10. In the substrate 10 according to this embodiment, terminals 12 as the number corresponding to the number of lands 13 are provided.

The multicore optical fiber 35 includes a plurality of optical fibers 30 equal to the optical fiber according to the first embodiment and the plurality of optical fibers 30 is arranged in a planar shape and is integrally gathered by a coating resin 36. At one end portion of the multicore optical fiber 35, each optical fiber 30 is led out from the coating resin 36 and a protective layer 33 in the same manner as the optical fiber 30 according to the first embodiment. If a length of a lead-out portion is set to a lead-out length, the lead-out length is preferably 10 μm to 15 mm, more preferably, 1.5 mm to 2.5 mm.

One end portion of each of the optical fibers 30 that has been led out is disposed on an element surface 21 of the photoelectric conversion element 22 at a position not overlapping a center of the light receiving/emitting unit 25 in the same manner as the case where one end portion of the optical fiber 30 according to the first embodiment is disposed on an element surface 21 of the photoelectric conversion element 20. One end portion of each of the optical fibers 30 that have been disposed corresponds to each of the light receiving/emitting units 25 one by one and a center line of each core 31 of each optical fiber 30 is located to substantially overlap the center of each light receiving/emitting unit 25. One end portion of each optical fiber 30 is more preferably disposed on the element surface 21 of the photoelectric conversion element 22 at a position not overlapping the entire light receiving/emitting unit 25.

In a state in which one end portion of each optical fiber 30 is disposed on the photoelectric conversion element 22, one end portion of each optical fiber 30 is fixed to the photoelectric conversion element 22 by a plurality of light transmitting resins 41 each of which is disposed to correspond to each optical fiber 30 and which is separated from each other, in the same manner as the case where one end portion of the optical fiber 30 according to the first embodiment is fixed by the light transmitting resin 41.

In the multicore optical fiber 35, the coating resin 36 and a part of a clad 32 of each optical fiber 30 exposed from the coating resin 36 are fixed to the substrate 10 by a fixing resin 45.

Here, if the multicore optical fiber 35 is cut by a fiber cutter, a position of an end face of each optical fiber 30 may deviate by about 20 μm in a longitudinal direction of the optical fiber 30 in a peak-to-peak manner. Here, when the clad 32 has a general outer diameter of 125 μm, as described above, a deviation of 20 μm corresponds to that D₁/D₂ deviates by ±0.1. As described above, if an angle θ of a predetermined region of a surface of the light transmitting resin 41 on which light is reflected is 40 degrees to 50 degrees with respect to a line perpendicular to a photoelectric conversion element surface, a coupling loss of light of the core 31 and the light receiving/emitting unit 25 can be sufficiently suppressed even when D₁/D₂ deviates by about ±0.1 from ±0.5. Therefore, by setting an inclination angle θ of the predetermined region of each light transmitting resin 41 to degrees to 50 degrees with respect to the line perpendicular to the photoelectric conversion element surface, an increase in the coupling loss of the light of the core 31 and the light receiving/emitting unit 25 can be suppressed even if the position of the end face of each optical fiber 30 deviates by about 20 μm in the longitudinal direction of the optical fiber 30 as described above. As such, when the position of the end face of the optical fiber 30 deviates in the longitudinal direction of the optical fiber 30, the position of each light transmitting resin 41 is preferably deviated in the longitudinal direction of the optical fiber 30 according to the deviation of the end face.

In the photoelectric conversion module 2, when the photoelectric conversion element 22 is a light emitting element, light is emitted from each light receiving/emitting unit 25, on the basis of an electric signal input to the terminal 12 of the photoelectric conversion module 2, in the same manner as the photoelectric conversion module 1 according to the first embodiment. The light emitted from each light receiving/emitting unit 25 is reflected by the predetermined region 42 of the surface of each light transmitting resin 41, is incident on the core 31 of each optical fiber 30, and propagates through each core 31 from one end portion to the other end portion.

On the other hand, in the case where the photoelectric conversion element 20 of the photoelectric conversion module 2 is a light receiving element, if light is emitted from one end portion of each optical fiber 30, the light emitted from each core 31 is reflected by the predetermined region 42 of the surface of each light transmitting resin 41 and is received by each light receiving/emitting unit 25. If the light is received by each light receiving/emitting unit 25, an electric signal is output from the terminal 12 of the photoelectric conversion module 1 in the same manner as the photoelectric conversion module 1 according to the first embodiment.

As described above, in the photoelectric conversion module 2 according to this embodiment, even when the multicore optical fiber 35 is used, the outer circumferential surface of the clad 32 of each optical fiber 30 contacts the element surface 21 and each light transmitting resin 41 optically connects the core 31 of each optical fiber 30 and each light receiving/emitting unit 25 individually. Therefore, in the photoelectric conversion module 2, the loss of the light can be reduced while the multicore optical fiber 35 is used. In addition, according to the photoelectric conversion module 2, the movement of the end portion of each optical fiber 30 is suppressed in the same manner as the case where the movement of the end portion of the optical fiber 30 according to the first embodiment is suppressed. Therefore, an increase in the coupling loss of the light in the core 31 of the optical fiber 30 and the light receiving/emitting unit 25 of the photoelectric conversion element 20 can be suppressed and height reduction can be realized in the same manner as the photoelectric conversion module 1 according to the first embodiment.

### <Active Optical Cable>

Next, an active optical cable according to this embodiment will be described.

FIG. 7 is a plan view showing the active optical cable according to this embodiment. As shown in FIG. 7, an active optical cable AC2 according to this embodiment includes a photoelectric conversion module 2A and a photoelectric conversion module 2B. The photoelectric conversion module 2A and the photoelectric conversion module 2B use a common multicore optical fiber 35.

The photoelectric conversion module 2A is a module in which the photoelectric conversion element 22 of the photoelectric conversion module 2 is replaced by a light emitting element 22A. That is, the photoelectric conversion module 2A is a light emitting module.

The light emitting element 22A has a plurality of light emitting units 25A corresponding to the plurality of light receiving/emitting units 25 of the photoelectric conversion element 22 of the photoelectric conversion module 2 and the element surface 21 of the photoelectric conversion module 2 corresponds to a light emitting element surface 21A of the light emitting element 22A. In addition, one end portion of each optical fiber 30 is fixed to the light emitting element 22A. Specifically, one end portion of each optical fiber 30 is led out in the same manner as one end portion of each optical fiber 30 of the photoelectric conversion module 2. In addition, one end portion of each optical fiber 30 that has been led out is disposed to contact the light emitting element surface 21A at a position where the outer circumferential surface of the clad 32 does not overlap the center of the light emitting unit 25A of the light emitting element 22A. One end portion of each optical fiber 30 disposed in this manner is fixed by a plurality of first light transmitting resins 41A having the same configurations as the configurations of the plurality of light transmitting resins 41 of the photoelectric conversion module 2 in the same manner as the case where one end portion of each optical fiber 30 of the photoelectric conversion module 2 is fixed to the photoelectric conversion element 22 by each light transmitting resin 41. One end portion of each optical fiber 30 is more preferably disposed to contact the light emitting element surface 21A at a position not overlapping the entire portion of each light emitting unit 25A of the light emitting element 22A.

In addition, the photoelectric conversion module 2B is a module in which the photoelectric conversion element 22 of the photoelectric conversion module 2 is replaced by a light receiving element 22B. That is, the photoelectric conversion module 2B is a light receiving module.

The light receiving element 22B has a plurality of light receiving units 25B corresponding to the plurality of light receiving/emitting units 25 of the photoelectric conversion element 22 of the photoelectric conversion module 2 and the element surface 21 of the photoelectric conversion module 2 corresponds to a light receiving element surface 21B of the light receiving element 22B. In addition, the other end portion of each optical fiber 30 is fixed to the light receiving element 22B. Specifically, the other end portion of each optical fiber 30 is led out in the same manner as one end portion of each optical fiber 30 of the photoelectric conversion module 2. The other end portion of each optical fiber 30 that has been led out is then disposed to contact the light receiving element surface 21B at a position where the outer circumferential surface of the clad 32 does not overlap a center of the light receiving unit 25B of the light receiving element 22B. The other end portion of each optical fiber 30 disposed in this manner is fixed by a plurality of second light transmitting resins 41B having the same configurations as the configurations of the plurality of light transmitting resins 41 of the photoelectric conversion module 1 in the same manner as the case where one end portion of each optical fiber 30 of the photoelectric conversion module 2 is fixed to the photoelectric conversion element 20 by each light transmitting resin 41. The other end portion of each optical fiber 30 is more preferably disposed to contact the light receiving element surface 21B at a position not overlapping the entire light receiving unit 25B of the light receiving element 22B.

In the active optical cable AC2 having the above configuration, light is emitted from each light emitting unit 25A, on the basis of an electric signal input to the terminal 12 of the photoelectric conversion module 2A, in the same manner as the active optical cable AC1 according to the first embodiment. Each light emitted from each light emitting unit 25A is reflected by the predetermined region 42 of the surface of each first light transmitting resin 41A and is incident on the core 31 of each optical fiber 30. In addition, each light propagates through the core 31 from one end portion of each optical fiber 30 to the other end portion. The light emitted from each core 31 at the other end portion is reflected by the predetermined region 42 of the surface of each second light transmitting resin 41B and is received by each light receiving unit 25B. If the light is received by each light receiving unit 25B, an electric signal is output from the terminal 12 of the photoelectric conversion module 2B in the same manner as the active optical cable AC1 according to the first embodiment.

As described above, in the active optical cable AC1, the loss of the light can be reduced between each optical fiber 30 and each light emitting element 22A or each light receiving element 22B in each of the photoelectric conversion modules 1A and 1B, in the same manner as the photoelectric conversion module 2. Therefore, efficient optical communication can be performed. In addition, in the active optical cable AC2, the movement of the end portion of each optical fiber 30 in each of the photoelectric conversion modules 2A and 2B is suppressed in the same manner as the photoelectric conversion module 2 and an increase in the coupling loss of the light in the core 31 and the light receiving/emitting unit 25 can be suppressed. Therefore, stable optical communication can be performed. In addition, in the active optical cable AC2, because each of the photoelectric conversion modules 2A and 2B can realize height reduction in the same manner as the photoelectric conversion module 2, miniaturization can be realized.

Although the present invention has been described using the first and second embodiments as the examples, the present invention is not limited thereto.

For example, in the second embodiment, each optical fiber 30 has the protective layer 33 and the protective layer 33 is covered by the coating resin 36. However, the protective layer 33 is not an essential configuration.

In addition, in the second embodiment, the photoelectric conversion element 22 has the plurality of light receiving units 25B. However, a form in which the plurality of light receiving/emitting units is provided is not limited to the second embodiment. Examples of the form can include a form in which the photoelectric conversion module includes a plurality of photoelectric conversion elements 20 equal to the photoelectric conversion element in the first embodiment. In this case, similar to the second embodiment, a plurality of light transmitting resins 41 may be provided and each light transmitting resin 41 may individually fix one end portion of each optical fiber 30 to each photoelectric conversion element 20 and reflect the light by the predetermined region 42 of the surface so that the core 31 of each optical fiber 30 and each light receiving/emitting unit 25 are optically coupled individually. In addition, the number of optical fibers 30 included in the multicore optical fiber 35 according to the second embodiment may be different from the number thereof in the above embodiments.

As described above, according to the present invention, the photoelectric conversion module in which the loss of the light is reduced and the active optical cable are provided and can be used as components in vehicles, home appliances, and other fields.

### REFERENCE SIGNS LIST

1, 1A, 1B, 2, 2A, 2B photoelectric conversion module
10 substrate
15 wiring line
20, 22 photoelectric conversion element
20A, 22A light emitting element
20B, 22B light receiving element
21 element surface
21A light emitting element surface
21B light receiving element surface
25 light receiving/emitting unit
25A light emitting unit
25B light receiving unit
26 light receiving/emitting surface
30 optical fiber
31 core
32 clad
33 protective layer
35 multicore optical fiber
36 coating resin
41 light transmitting resin
41A first light transmitting resin
41B second light transmitting resin
AC1, AC2 active optical cable

1. A photoelectric conversion module comprising:
a photoelectric conversion element which has a light receiving/emitting unit to receive or emit light;
an optical fiber which has one end portion fixed to the photoelectric conversion element; and
a light transmitting resin which fixes the one end portion of the optical fiber and the photoelectric conversion element, reflects light by a predetermined region of a surface thereof, and optically couples a core of the optical fiber and the light receiving/emitting unit, wherein
an outer circumferential surface of a clad at the one end portion of the optical fiber contacts an element surface from which the light receiving/emitting unit is exposed at a position not overlapping a center of the light receiving/emitting unit in the photoelectric conversion element.

2. The photoelectric conversion module according to claim 1, wherein a distance between an end face of the optical fiber and a center position of the light receiving/emitting unit in a longitudinal direction of the optical fiber is equal to a distance from the element surface to a center of the core.

3. The photoelectric conversion module according to claim 1, wherein the predetermined region of the surface of the light transmitting resin reflecting the light is inclined at 40 degrees to 50 degrees with respect to a direction perpendicular to the light receiving/emitting unit.

4. The photoelectric conversion module according to claim 1, further comprising:
a substrate to which the photoelectric conversion element is fixed; and
a fixing resin which fixes the optical fiber to the substrate, wherein
the light transmitting resin is softer than the fixing resin.

5. The photoelectric conversion module according to claim 1, wherein a plurality of the light receiving/emitting units, a plurality of the optical fibers, and a plurality of the light transmitting resins are provided,
the plurality of optical fibers is gathered by a coating resin and is led out from the coating resin by a predetermined length so that the clad is exposed at the one end portion,
each of the light transmitting resins individually fixes the one end portion of each of the optical fibers to the photoelectric conversion element, reflects light by the predetermined region of the surface thereof, and optically couples the core of each of the optical fibers and each of the light receiving/emitting units individually, and
the outer circumferential surface of the clad at the one end portion of each of the optical fibers contacts the element surface at a position not overlapping the center of the light receiving/emitting unit.

6. The photoelectric conversion module according to claim 5, further comprising:
a substrate to which the photoelectric conversion element is fixed; and
a fixing resin which fixes each of the optical fibers to the substrate, wherein
the light transmitting resin is softer than the fixing resin.

7. An active optical cable comprising:
a light emitting element which has a light emitting unit to emit light;
a light receiving element which has a light receiving unit to receive the light;
an optical fiber which has one end portion fixed to the light emitting element and the other end portion fixed to the light receiving element;
a first light transmitting resin which fixes the one end portion of the optical fiber and the light emitting element, reflects light by a predetermined region of a surface thereof, and optically couples a core of the optical fiber and the light emitting unit; and
a second light transmitting resin which fixes the other end portion of the optical fiber and the light receiving element, reflects light by a predetermined region of a surface thereof, and optically couples the core of the optical fiber and the light receiving unit, wherein
an outer circumferential surface of a clad at the one end portion of the optical fiber contacts a light emitting element surface from which the light emitting unit is exposed at a position not overlapping a center of the light emitting unit in the light emitting element and an outer circumferential surface of the clad at the other end portion of the optical fiber contacts a light receiving element surface from which the light receiving unit is exposed at a position not overlapping a center of the light receiving unit in the light receiving element.

8. The photoelectric conversion module according to claim 2, wherein the predetermined region of the surface of the light transmitting resin reflecting the light is inclined at 40 degrees to 50 degrees with respect to a direction perpendicular to the light receiving/emitting unit.

9. The photoelectric conversion module according to claim 2, further comprising:
a substrate to which the photoelectric conversion element is fixed; and
a fixing resin which fixes the optical fiber to the substrate, wherein
the light transmitting resin is softer than the fixing resin.

10. The photoelectric conversion module according to claim 2, wherein a plurality of the light receiving/emitting units, a plurality of the optical fibers, and a plurality of the light transmitting resins are provided,
the plurality of optical fibers is gathered by a coating resin and is led out from the coating resin by a predetermined length so that the clad is exposed at the one end portion,
each of the light transmitting resins individually fixes the one end portion of each of the optical fibers to the photoelectric conversion element, reflects light by the predetermined region of the surface thereof, and optically couples the core of each of the optical fibers and each of the light receiving/emitting units individually, and
the outer circumferential surface of the clad at the one end portion of each of the optical fibers contacts the element surface at a position not overlapping the center of the light receiving/emitting unit.

11. The photoelectric conversion module according to claim 10, further comprising:
a substrate to which the photoelectric conversion element is fixed; and
a fixing resin which fixes each of the optical fibers to the substrate, wherein
the light transmitting resin is softer than the fixing resin.

12. The photoelectric conversion module according to claim 3, further comprising:
a substrate to which the photoelectric conversion element is fixed; and
a fixing resin which fixes the optical fiber to the substrate, wherein
the light transmitting resin is softer than the fixing resin.

13. The photoelectric conversion module according to claim 3, wherein a plurality of the light receiving/emitting units, a plurality of the optical fibers, and a plurality of the light transmitting resins are provided,
the plurality of optical fibers is gathered by a coating resin and is led out from the coating resin by a predetermined length so that the clad is exposed at the one end portion,
each of the light transmitting resins individually fixes the one end portion of each of the optical fibers to the photoelectric conversion element, reflects light by the predetermined region of the surface thereof, and optically couples the core of each of the optical fibers and each of the light receiving/emitting units individually, and
the outer circumferential surface of the clad at the one end portion of each of the optical fibers contacts the element surface at a position not overlapping the center of the light receiving/emitting unit.

14. The photoelectric conversion module according to claim 13, further comprising:
a substrate to which the photoelectric conversion element is fixed; and
a fixing resin which fixes each of the optical fibers to the substrate, wherein
the light transmitting resin is softer than the fixing resin.
